(19) United States
(12) Patent Application Publication
(10) Pub. No.: US 2009/0232974 A1
(43) Pub. Date: Sep. 17, 2009

(54) Method of Maintaining Floor Covering Layer, and Grinding Apparatus for Use in Said Method

(75) Inventors: Tadayoshi Fujimoto, Osaka (JP); Isao Morita, Osaka (JP); Katsuaki Namba, Osaka (JP)

Correspondence Address: POSZ LAW GROUP, PLC, 12040 SOUTH LAKES DRIVE, SUITE 101, RESTON, VA, 20191, US

(73) Assignee: Penguin Wax Co., Ltd., Higashinari-ku, Osaka-shi (JP)

(21) Appl. No.: 12/084,048

(22) PCT Filed: Oct. 28, 2005
(86) PCT No.: PCT/JP2005/019897

§ 371 Date: Jul. 10, 2008

(51) Int. Cl. B32B 43/00; B05D 3/12; B24B 7/00

(52) U.S. Cl. 427/140; 451/164

(57) ABSTRACT

The present invention makes it possible to simplify the work of maintaining the covering performance of a covering layer by a method for maintaining a floor covering layer whereby the covering performance of a covering layer B that is formed on a floor (A) and covers the floor (A) can be maintained. In this method, the resin covering layer B having a thickness (T0) of 30 to 100 μm is formed on the floor. The surface of the resin covering layer B is subjected to dry grinding without the use of a liquid by using grinding pads (6) and (7) provided with grinding surfaces (6a) and (7a) that move along one direction. The generated grindings are recovered, and a layering material (26) for the resin covering layer is then coated onto the resin covering layer (B) to restore the thickness (T1) of the resin covering layer (B), which has been reduced by grinding, to substantially an original thickness (T0). This thickness restoration work is carried out with proper timing that corresponds to a reduction in the covering performance to maintain the covering performance of the covering layer (B).

### TECHNICAL FIELD

The present invention relates to a method of maintaining a floor covering layer designed to maintain the covering performance of a covering layer that is formed on a floor and that covers the floor, and to a grinding apparatus for use in this method.

### BACKGROUND ART

A covering layer formed on a floor to cover the floor in order to protect the floor and maintain aesthetic appearance is generally formed by applying resin wax, water-based wax, or another covering layer layering material in a thickness of 10 to 20 μm.

In conventional methods of maintaining a floor covering layer, the surface of the covering layer is washed with an aqueous washing solution and covered with wax each time the covering layer wears out, is damaged, or otherwise loses its covering performance. In cases in which soil becomes firmly deposited by repetition of the above process or the reduced covering performance cannot be restored, the entire covering layer is removed from the floor by washing the floor with an aqueous wax removal solution. A covering layer layering material is thereafter again coated onto the surface of the floor, and a new covering layer is formed. This kind of work is suitably carried out as needed in response to the deterioration of covering performance. (This is a well-known customary technique, and prior art document information cannot be disclosed.)

### DISCLOSURE OF THE INVENTION

### Problems that the Invention is Intended to Solve

However, a large amount of washing wastewater is generated when the surface of a covering layer is washed using an aqueous washing solution and when an aqueous wax removal solution is used to wash the entire covering layer and remove the layer from the floor. There is a need to recover this washing wastewater from the floor and discard the wastewater after processing the wastewater appropriately so as to reduce the impact on the environment.

Also, there is a need to sufficiently dry the floor so that adhesiveness of the covering layer to the floor can be assured again before a new covering layer layering material is coated onto the floor. This treatment has a drawback in that the work becomes more laborious with larger floor surfaces.

Furthermore, there is a disadvantage in that controlling the entrance of people to the work area and other management work is made more laborious because soil that adheres to shoes and the like is readily transferred to the surface of the floor via the aqueous washing or removal solutions that remain on the floor when people pass over a washed but not yet fully dried floor.

The present invention was contrived in view of the foregoing, and an object of the present invention is to simplify the work of maintaining the covering performance of a covering layer.

### Means for Solving the Problems

A first aspect of the present invention is a method of maintaining a floor covering layer designed to maintain the covering performance of a covering layer that is formed on the surface of a floor and covers the surface of the floor, the method comprising forming a resin covering layer having a thickness of 30 to 100 μm on a surface of a floor; dry grinding the surface of the resin covering layer without the use of a liquid by using a grinding tool provided with a grinding surface that moves along a single direction; recovering grindings thus generated; thereafter coating a layering material for the resin covering layer onto the resin covering layer; and carrying out work for restoring the thickness of the resin covering layer, which has been reduced by grinding, to substantially an original thickness with proper timing that corresponds to a reduction in the covering performance to maintain the covering performance of the covering layer.

A second aspect of the present invention is that the resin covering layer is a covering layer having acrylic resin as a principal material.

A third aspect of the present invention is a grinding apparatus used in the method for maintaining a floor covering layer according to the first or second aspect, comprising a pair of grinding tools provided with grinding surfaces that are capable of reciprocating movement along a single direction, the tools being disposed facing each other in a reciprocating movement direction and capable of simultaneous reciprocating driving movement so that the movement directions thereof are mutually opposing directions.

### EFFECT OF THE INVENTION

In accordance with the first aspect, the surface of the resin covering layer is dry ground without the use of a liquid, rather than being subjected to a procedure in which the resin covering layer formed on the floor, i.e., the surface of the resin covering layer, is washed using an aqueous washing solution or an aqueous wax removal solution to remove the entire covering layer from the floor in accordance with reduced covering performance. After the generated grindings have been recovered, a layering material for the resin covering layer is coated onto the resin covering layer, and the work of restoring the thickness of the resin covering layer, which has been reduced by grinding, to substantially an original thickness is carried out to maintain the covering performance of the covering layer. For this reason, there is no particular generation of the washing wastewater that is conventionally produced. Also, adhesion between the resin covering layer and the floor are not compromised and the covering performance of the covering layer can be maintained.

Also, for example, there is a disadvantage in that locations where contact is made tend to be more deeply ground in the outward radial direction of the grinding surface, and it is difficult to achieve uniform grinding because the peripheral velocity of the grinding surface is greater toward the outward radial side when the surface of the resin covering layer is ground using grinding tools provided with circular grinding surfaces that rotate about a vertical axis. However, with the present configuration, it is easy to substantially uniformly grind substantially the entire surface in locations where contact is made with the grinding surfaces. This is because the surface of the resin covering layer is ground using grinding tools that are provided with a grinding surface that moves along a single direction. As a result, the layering material for the resin covering layer is coated substantially uniformly in the ground resin covering layer, and the resin covering layer that has been reduced by grinding can be easily restored to substantially the original thickness.

In addition, a resin covering layer having a thickness of 30 to 100 μm is formed on a floor, and work is carried out to restore the thickness of the resin covering layer, which has been reduced by grinding, to substantially the original thickness. Therefore, a resin covering layer having excellent covering performance can be restored.

A resin covering layer having a thickness of less than 30 μm has poor impact absorptivity and is easily damaged. As a result, soil enters into damaged locations, and it is difficult to maintain aesthetic appearance over long periods. Also, resin covering layers having a thickness 100 μm or more have poor transparency, and surface smoothness is additionally difficult to maintain. In contrast, a resin covering layer having a thickness between 30 and 100 μm has high impact absorptivity and is resistant to damage while ensuring transparency and surface smoothness, and a resin covering layer having excellent covering performance can be restored.

In accordance with the second aspect, the resin covering layer having acrylic resin as a principal material is formed on a floor, and the work of maintaining the covering performance of the covering layer is carried out with proper timing that corresponds to a reduction in covering performance. Therefore, a hard resin covering layer that is highly transparent and resistant to damage can be restored.

In accordance with the third aspect, a grinding apparatus is used comprising a pair of grinding tools provided with grinding surfaces that are capable of reciprocating movement along a single direction, the tools being disposed facing each other in a reciprocating movement direction and capable of simultaneous reciprocating driving movement so that the movement directions thereof are mutually opposing directions. Therefore, reaction forces that act on the main apparatus in accompaniment with the movement of each of the grinding tools are made to act in mutually canceling directions, and the resin covering layer can be ground in a state of low vibration and impact.

### BRIEF DESCRIPTION OF THE DRAWINGS

FIG. 1 is a perspective view of a floor working machine;

FIG. 2 is a side view showing the grinding apparatus;

FIG. 3 is a plan view showing the grinding apparatus; and

FIG. 4 is an explanatory diagram of the method of maintaining a floor covering layer.

### KEY

6 Grinding pad (grinding tool)
6a Ground surface
7 Grinding pad (grinding tool)
7a Grinding surface
26 Layering material for resin covering layer
A Floor
B Covering Layer
T0, T1 Thicknesses

### BEST MODE FOR CARRYING OUT THE INVENTION

Embodiments of the present invention are described below with reference to diagrams.

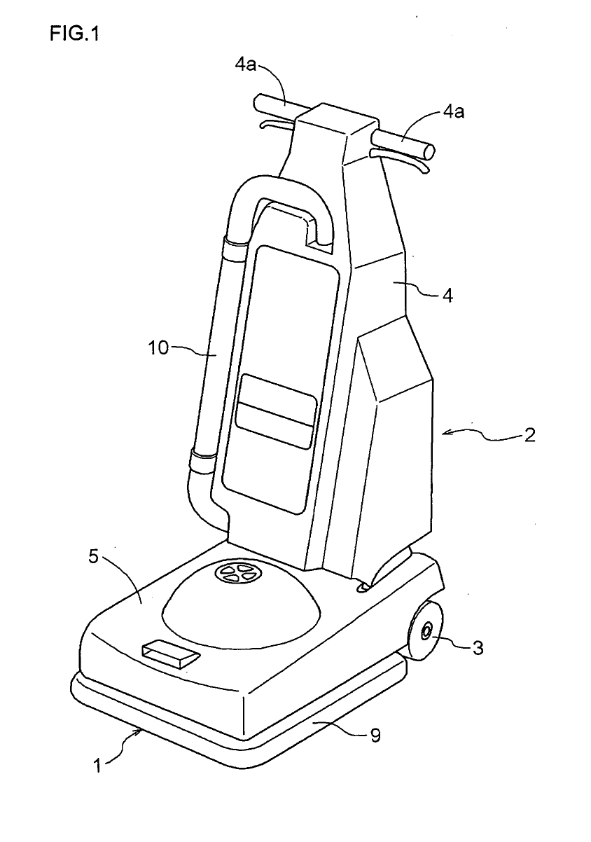

FIGS. 1 through 3 show floor working machine 2 driven by an electric motor and provided with a grinding apparatus 1 that is used in the method of maintaining a floor covering layer in accordance with the present invention. The covering performance of a resin covering layer B that is formed on the surface of a floor A and that covers the surface of the floor A can be maintained by the grinding apparatus 1.

A floor working machine 2 has a grinding apparatus 1 in which a machine casing 5, which is provided with a pair of left and right carrier wheels 3 in the rear portion and a control handle 4 on which grips 4a are disposed, has a pair of grinding pads (an example of grinding tools) 6 and 7 that are disposed below the machine casing 5 and are provided with rectangular grinding surfaces 6a and 7a capable of reciprocating movement along a single direction, i.e., the forward/rearward direction of the machine casing. Grindings generated by the operation of the grinding apparatus 1 are suctioned and recovered using a recovery part 8 that is provided to the interior of the control handle 4. Provided for this task are a skirt 9 made of sheet rubber that encompasses the circumference of the grinding apparatus 1, and a suction hose 10 having a suction fan (not shown) that suctions the space inside the skirt 9. A HEPA filter 11 for filtering discharge air is provided, and the filter is configured so that clean air can be exhausted.

Through holes may be provided to the skirt 9 so that air is uniformly suctioned by the suction fan from the outside of the skirt 9 toward the inside. For example, a plurality of through holes (not shown) are provided to the skirt 9 of the front, back, and side surfaces of the vehicle body so as to form a row at a height position that has a fixed distance from the floor A or at a height position that is even with the floor A.

However, there is a tendency for grindings to be left on the floor A as the floor working machine 2 is moved forward when the through holes in the skirt 9 on the back surface of the vehicle body are provided at a position that is even with the floor A. In order to avoid such a disadvantage, the through holes in the back surface are preferably set at a height position that has a fixed distance from the floor A.

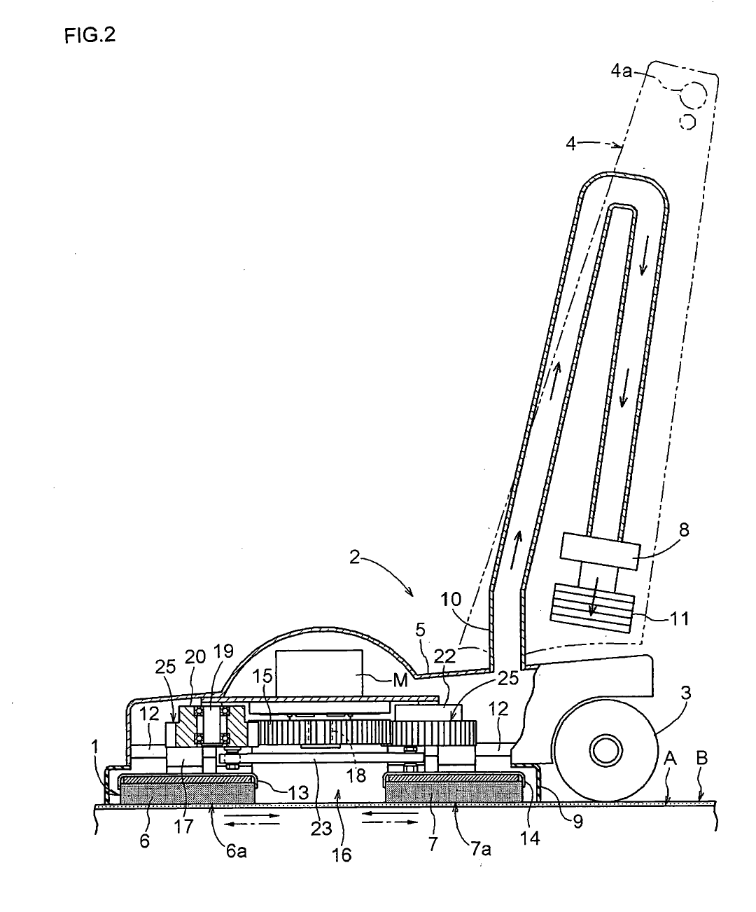

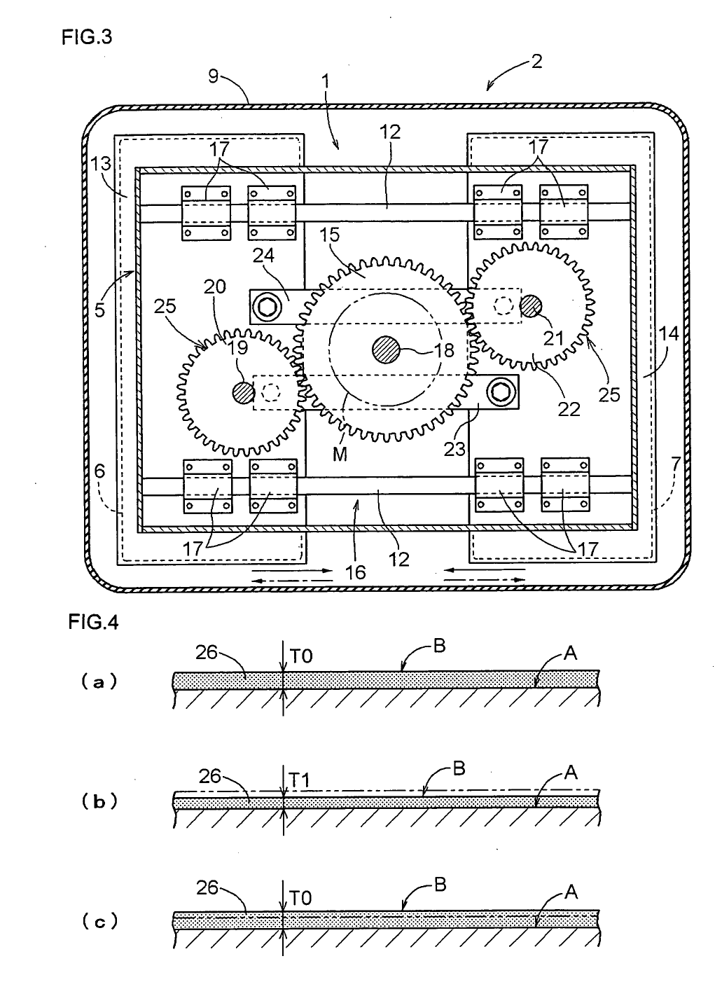

As shown in FIGS. 2 and 3, the grinding apparatus 1 is provided with a pair of left and right guide rails 12 in the inner part of the machine casing 5, a pair of front and back pad supports 13 and 14, a pair of front and back grinding pads 6 and 7, and a pad control apparatus 16 that is capable of performing simultaneous reciprocating driving movement so that the movement directions of the pair of grinding pads 6 and 7 are facing each other.

The guide rails 12 are composed of round rods along the front and back of the vehicle body, and are secured across the front end part and the back end part of the machine casing 5.

The pad support 13 of the front side is slidably mounted on the respective front end sides of the pair of left and right guide rails 12 using a pair of left and right mounting blocks 17 which are secured to the upper surface side. The pad support 14 of the back side is slidably mounted to the respective back end sides of the pair of left and right guide rails 12 using a pair of left and right mounting blocks 17, which are secured to the upper surface side.

The front and back pair of pad supports 13 and 14 are positioned on the bottom part of the machine casing 5 and are aligned along the forward/rearward direction of the vehicle body. Each of the supports presents a long rectangle in the lateral direction of the vehicle body as viewed from above.

The front and back pair of grinding pads 6 and 7 are aligned along the forward/rearward direction of the vehicle body beneath the machine casing 5, and are made to face in mutually opposing reciprocating movement directions. Each of the pads presents a long rectangle in the lateral direction of the vehicle body as viewed from above.

The grinding pads 6 and 7 are formed by securing fine ceramic abrasive grains to fibers.

The grinding pad 6 of the front side is detachably mounted on the bottom surface side of the pad support 13 on the front side. The front side grinding pad is slidably supported in the forward/rearward direction of the vehicle body by using the machine casing 5 via the pad support 13 and the pair of left and right guide rails 12.

The grinding pad 7 of the back side is detachably mounted on the bottom surface side of the pad support 14 on the back side. The front side grinding pad is slidably supported in the forward/rearward direction of the vehicle body by using the machine casing 5 via the pad support 14 and the pair of left and right guide rails 12.

The pad control apparatus 16 is provided with a large-diameter gear 15, rotation controllers 20 and 21, a link 23 that connects the rotation controller 20 and the pad support 14 of the back side, and a link 24 that connects a rotation controller 22 and the pad support 13 of the front side.

The large-diameter gear 15 is positioned in the center of the interior of the machine casing 5 and is integrally and rotatably connected to an output shaft 18 that protrudes downward in the vehicle body from a motor M disposed inside the machine casing 5.

The rotation controller 20 is supported while allowed to rotate about a support shaft 19, which is secured to the machine casing 5 at one of a pair of locations separated on the forward and rearward sides, and the left and right sides of the large-diameter gear 15. The rotation controller 22 is supported while allowed to rotate about a support shaft 21, which is secured to the machine casing 5 at the other of the two locations.

One end of the link 23 is connected to a location that is eccentric relative to the axial center of rotation of one of the rotation controllers 20 on the inside of the machine casing 5 so as to be capable of relative rotation, and the other end is connected to the upper surface side of the pad support 14 on the back side so as to be capable of relative rotation.

One end of the link 24 is connected to a location that is eccentric relative to the axial center of rotation of the other rotation controller 22 so as to be capable of relative rotation, and the other end is connected to the upper surface side of the pad support 13 on the front side so as to be capable of relative rotation.

The pair of rotation controllers 20 and 22 are both provided with a gear part 25 on the lower end sides thereof, and the gear part 25 engages the large-diameter gear 15.

Accordingly, the pair of grinding pads 6 and 7 reciprocates and slides so to move along the left and right guide rails 12 in the forward/rearward direction of the vehicle body and in mutually opposite directions when the pad control apparatus 16 is driven by the motor M.

In other words, the large-diameter gear 15 is driven during driving of the motor M, and the pair of rotation controllers 20 and 22 are rotated in interlocked fashion. At this time, the links 23 and 24, which are connected to the rotation controllers 20 and 22, respectively, convert the rotational force of the rotation controllers 20 and 22 into the linear force of reciprocation. This force causes the pad supports 13 and 14 to slide in a reciprocating fashion along the left and right guide rails 12, whereby the grinding pads 6 and 7 are caused to move in a reciprocating fashion in the forward/rearward direction of the machine casing 5 along the left and right guide rails 12. The pair of rotation controllers 20 and 22, because of the manner in which the assembly phases of these controllers is set, slidably operate the pad supports 13 and 14 in mutually opposite directions so that when one of the pad supports 13 slides in the rearward direction of the vehicle body, the other pad support 14 slides in the forward direction of the vehicle body.

Therefore, the grinding apparatus 1 is configured so that the surface of the resin covering layer B that is formed on the floor A and covers the floor A in a bonded state is ground by the front and back pair of grinding pads 6 and 7 when the large-diameter gear 15 is rotatably driven by the motor M in a state where the grinding pads 6 and 7 are placed on the floor A, and the pad control apparatus 16 is driven so as to movably drive the front and back pair of grinding pads 6 and 7 in the forward/rearward direction of the vehicle body and in mutually opposite directions on the surface of the floor.

The method of maintaining a floor covering layer according to the present invention is described below.

The floor A is cleaned and dried, and an acrylic resin polymer coating agent 26, which is a layering material for a resin covering layer, is then coated onto the floor A so that the thickness T0 is 30 to 100 μm, as shown in FIG. 4(a). Accordingly, the resin covering layer B having acrylic resin as a principal material can be formed on the floor A in a bonded state.

The restoration work for restoring the original covering performance is carried out with proper timing that corresponds to the reduced covering performance, and the covering performance of the covering layer B is maintained when the resin covering layer B wears out, is damaged, or otherwise loses covering performance.

The restoration work is implemented in the following manner.

In other words, dust and waste matter on the surface of the resin covering layer B is removed using a dust mop or the like, the surface of the resin covering layer B is thereafter dry ground into a powdery state without the use of a liquid by using the grinding apparatus 1 of the floor working machine 2 (FIG. 4(b)). The generated powdery grindings are suctioned using the suction hose 10 and recovered by the recovery part 8. Water is wiped and dried from the resin covering layer surface B, the acrylic resin polymer coating agent 26 is thereafter coated onto the resin covering layer B, and the thickness T1 of resin covering layer B, which has been reduced by grinding, is restored to substantially an original thickness T0 (FIG. 4(c)).

### Other Embodiments

1. In the method of maintaining a floor covering layer according to the present invention, the generated grindings may be recovered separately after the surface of the resin covering layer has been ground in the restoration work.

2. In the method of maintaining a floor covering layer according to the present invention, a grinding tool may be used in which rollers or endless belts that are configured using the external peripheral surface as the grinding surface may be driven and rotated to perform grinding.

### INDUSTRIAL APPLICABILITY

The method of maintaining a floor covering layer according to the present invention and the grinding apparatus used in the method are very useful for maintaining the covering performance of a covering layer that is formed on that floor and covers the floor.

1-3. (canceled)

4. A grinding apparatus for a covering layer that is formed on the surface of a floor and covers the surface of the floor, the apparatus comprising:
a pair of grinding tools that are provided with grinding surfaces capable of reciprocating movement along a single direction, and that are disposed facing each other in a reciprocating movement direction and capable of simultaneous reciprocating driving movement so that the movement directions thereof are mutually opposing directions; and
a skirt that encompasses the circumference of the grinding tools in order to recover generated grindings.

5. A method of maintaining a floor covering layer designed to maintain the covering performance of a floor covering layer by using the grinding apparatus according to claim 4, the method comprising:
a step for dry grinding a surface of a resin covering layer that is formed on a floor and has a thickness of 30 to 100 μm by using a grinding tool;
a step for recovering generated grindings; and
a step for coating a layering material for the resin covering layer onto the resin covering layer that has been reduced by grinding, and restoring a thickness of the resin covering layer to substantially an original thickness.

6. The method for maintaining a floor covering layer according to claim 5, wherein the resin covering layer is a covering layer having acrylic resin as a principal material.
